(19) United States
(12) Patent Application Publication
(10) Pub. No.: US 2014/0014862 A1
(43) Pub. Date: Jan. 16, 2014

(54) VALVE HAVING A POLE CORE

(71) Applicant: EAGLE ACTUATOR COMPONENTS GMBH & CO. KG, Weinheim (DE)

(72) Inventor: Joerg BITTNER, Laudenbach (DE)

(21) Appl. No.: 13/911,301

(22) Filed: Jun. 6, 2013

(30) Foreign Application Priority Data
Jul. 13, 2012 (DE) 10 2012 013 820.2

(51) Int. Cl. F16K 31/06

(52) U.S. Cl. CPC F16K 31/06
USPC 251/129.15

(57) ABSTRACT

A valve comprising an electromagnetic actuation device having a pole core, a coil which encloses the pole core, and a magnetic yoke element which is associated with the coil, wherein a sealing body is provided which can be moved by a magnetic field, wherein the sealing body is connected to an armature, and wherein the armature can be moved relative to the pole core when the magnetic field is generated, valve which is to be produced with a view to solving the problem of producing an electromagnetically actuated valve which has a compact design and can be opened and closed without any problems, characterized in that the pole core projects into the armature, wherein the pole core, at its end facing the sealing body, is designed in an area in such a manner that the predominant portion of the magnetic flux, between the side of the armature that faces away from the sealing body, and the pole core, is guided through an air gap between the armature and the pole core, as a result of which the armature is pulled toward the pole core.

### CROSS REFERENCE TO RELATED APPLICATIONS

This application claims priority to German Patent Application No. 10 2012 013 820.2 filed on Jul. 13, 2012, the disclosure of which is incorporated by reference herein in its entirety.

### FIELD OF THE INVENTION

The invention relates to a valve comprising an electromagnetic actuation device having a pole core, a coil which encloses the pole core, and a magnetic yoke element which is associated with the coil, wherein a sealing body is provided which can be moved by a magnetic field, wherein the sealing body is connected to an armature, and wherein the armature can be moved relative to the pole core when the magnetic field is generated, wherein the pole core projects into the armature, wherein the pole core, on its end facing the sealing body, is designed in an area in such a manner that the predominant portion of the magnetic flux, between the side of the armature that faces away from the sealing body, and the pole core, is guided through an air gap between the armature and the pole core, as a result of which the armature is pulled toward the pole core.

### BACKGROUND

Valves in which a sealing body can be raised by a magnetic field from a sealing seat are already known from the prior art. As a result, an inlet of a valve is connected fluidically to an outlet. For the generation of a magnetic field, coils are used in electromagnetic actuation devices. The coils are enclosed by magnetic yoke elements in which the magnetic field or the magnetic flux is guided.

A yoke element usually interacts with an armature, in which the magnetic flux is conducted from the yoke element into the armature. As a result, the armature is moved. The sealing body is usually connected to the armature and it can be moved indirectly by the movement of the armature. From the prior art, constructions are known in which an armature is held concentrically within a magnetic yoke element. Here, the armature projects over a so-called guide section into the interior of the yoke element. Along the guide section, the armature is enclosed by the yoke element.

In order to produce the movement of the armature, the yoke element must have different wall thicknesses along the guide section, in order to force the magnetic flux into the armature. Very small wall thicknesses can occur here, which can affect the stability of the valve. Moreover, the ratio of the guide section to the outer diameter of the armature must be within a certain interval.

The technically required minimum dimensions of the armature, particularly of its outer diameter, are obtained on the basis of the forces required for opening the valve. However, the greater the required outer diameter of the armature is, the longer the guide section has to be. This usually leads to a heavy and voluminous armature body.

### SUMMARY

The invention is therefore based on the problem of producing an electromagnetically actuated valve which has a compact design and can be opened and closed without any problems.

A valve according to the invention comprises an electromagnetic actuation device having a pole core, a coil which encloses the pole core, and a magnetic yoke element which is associated with the coil, wherein a sealing body is provided which can be moved by a magnetic field, wherein the sealing body is connected to an armature, and wherein the armature can be moved relative to the pole core when the magnetic field is generated.

It is provided according to the invention that the pole core projects into the armature, wherein the pole core, at its end facing the sealing body, is designed in such a manner in an area that the predominant portion of the magnetic flux, between the side of the armature that faces away from the sealing body and the pole core, is guided through an air gap between the armature and the pole core, as a result of which the armature is pulled toward the pole core.

According to the invention it has been recognized that the magnetic flux in the area must be guided in such a manner that the armature is moved through said area. In concrete terms, it has been observed that the permeability has to be very low in the area, while the magnetic flux density must be very high. If a certain magnetic field strength has been exceeded, a predominant portion of the magnetic flux is pushed into the radially adjacent armature, as a result of which the latter is moved in the axial direction. According to the invention, the pole core here projects at least partially into the armature. In this manner, space can be saved and a compact valve design can be achieved. Consequently, the problem posed at the start has been solved.

The pole core can possibly have a constriction at its end facing the sealing body. A constriction makes it possible to narrow the pole core beneath the constriction, and to guide the armature directly on the pole core. The constriction must have a certain thickness in order to move the armature reliably, on the one hand, and to ensure, on the other hand, that the pole core is not weakened excessively in the area of the constriction.

The constriction can possibly form, out of the pole core, a guide pin along which the armature is guided. As a result, the sealing body can be moved in a tilt-free manner in the axial direction. The guide pin is made of the same material as the pole core, forming a single piece with the latter. The pole core and the armature are made from magnetic materials.

Between the guide pin and the armature, a bushing can possibly be arranged. The bushing supports and guides the movement of the armature. In this manner, friction occurring when the armature is being moved can be optimized.

Within the guide pin, a spring element can possibly be arranged, against which the sealing body can be moved. As soon as the magnetic field is no longer active, the sealing body is pushed back by the spring element against the sealing seat.

On the pole core, an abutment can possibly be formed, against which the armature can be applied in the axial direction. Due to the abutment, the movement of the armature can be stopped.

The guide pin can possibly have an outer diameter that is less than a first outer diameter of the pole core. As a result of this constructive measure, the armature can be aligned substantially with a circumferential surface of the pole core.

Against this backdrop, the pole core can possibly have in the area of the constriction a second outer diameter which is smaller than its first smaller outer diameter, wherein the pole core has, in an area between the constriction and the area of the first outer diameter, a step-like area having a third outer diameter, which is smaller than its first outer diameter but greater than its second outer diameter. In this manner, a step-like shape in the pole core can be produced. The stepping produces the abutment for the armature. In particular, however, the shape of the step-like form determines the force ratios required to move the armature.

At the end face of the guide pin, an end abutment for the sealing body can possibly be formed. In this manner, the armature is also stabilized by the sealing body against tilting, since the sealing body can bear against the guide pin.

An inlet and outlet can possibly be provided, which can be connected fluidically by raising the sealing body from a sealing seat. In this manner, the valve can be used as a regeneration valve or as an electrical recirculation valve in motor vehicles. The valve can be designed so that it is normally closed or open.

In principle, the valve construction described here could be used with all the magnet valves. Advantageously, it is possible to provide a guide at the same time in the manufacture of a pole core, for example, by turning. In this manner, the tolerances are reduced and optimized. The manufacture of a guide, particularly of a guide pin and of a pole core from the same material, is particularly advantageous. This is made possible by providing a constriction which produces a rapid saturation in the constriction area. Here, it is advantageous that only small energy losses occur. The disadvantages of the valves of the prior art, in which an inner guide of an armature is implemented, have been remedied. In some valves, a separately pressed-in guide pin is provided. Therefore, some of the known valves have components that require the additional manufacturing and adjustment processes. In the manufacture of the valve described here, these processes are no longer required.

### BRIEF DESCRIPTION OF THE DRAWING

FIG. 1 shows a cross-sectional view of an electromagnetically actuatable valve having a pole core which has a constriction, wherein the constriction forms, out of the pole core, a guide pin composed of a single material for an armature;

FIG. 2 shows an enlarged view of the pole core together with the armature; and

FIG. 3 shows an additional cross-sectional view of the valve according to FIG. 1, wherein an inlet, and an outlet, and a sealing body which is axially movable are represented.

### DETAILED DESCRIPTION

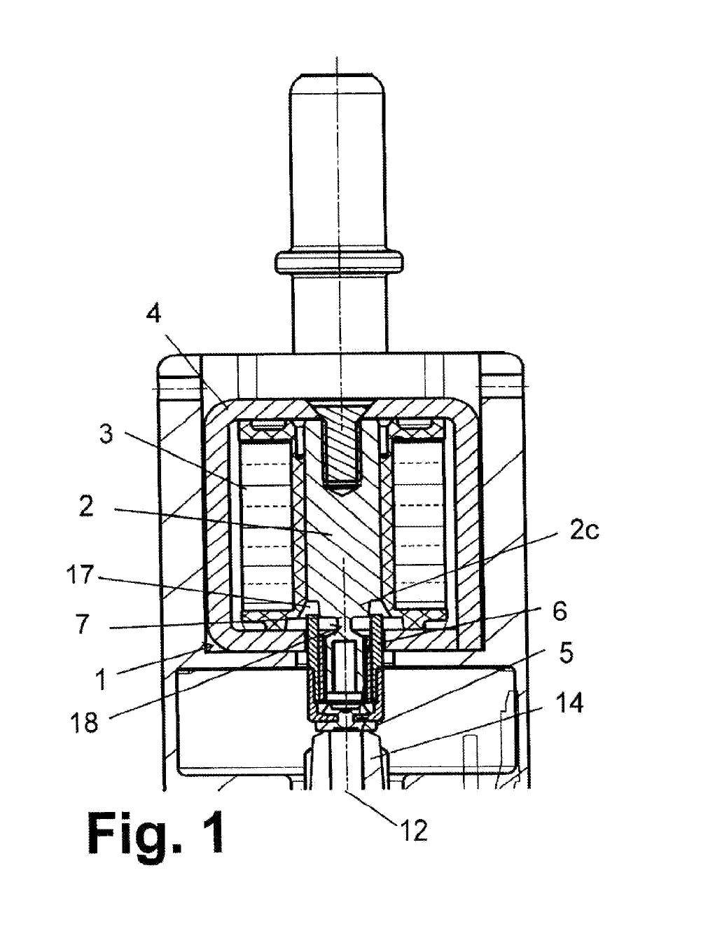

FIG. 1 shows a valve comprising an electromagnetic actuation device 1 having a pole core 2, a coil 3 which encloses the pole core 2, and a magnetic yoke element 4 which is associated with the coil 3, wherein a sealing body 5 is provided which can be moved by a magnetic field, wherein the sealing body 5 is connected to an armature 6, and wherein the armature 6 can be moved relative to the pole core 2 when the magnetic field is generated. In the case of a movement of the armature 6, the sealing body 5 is moved along with said armature. The yoke element 4 encloses the coil 3 or clasps said coil.

The pole core 2 extends into the armature 6, wherein the pole core 2 is formed on its end facing the sealing body 5 in such a manner in an area 18 that the predominant portion of the magnetic flux between the side of the armature 6 that faces away from the sealing body 5, and the pole core 2, is guided or can be guided through an air gap 17 between the armature 6 and the pole core 2, as a result of which the armature 6 is pulled or can be pulled toward the pole core 2.

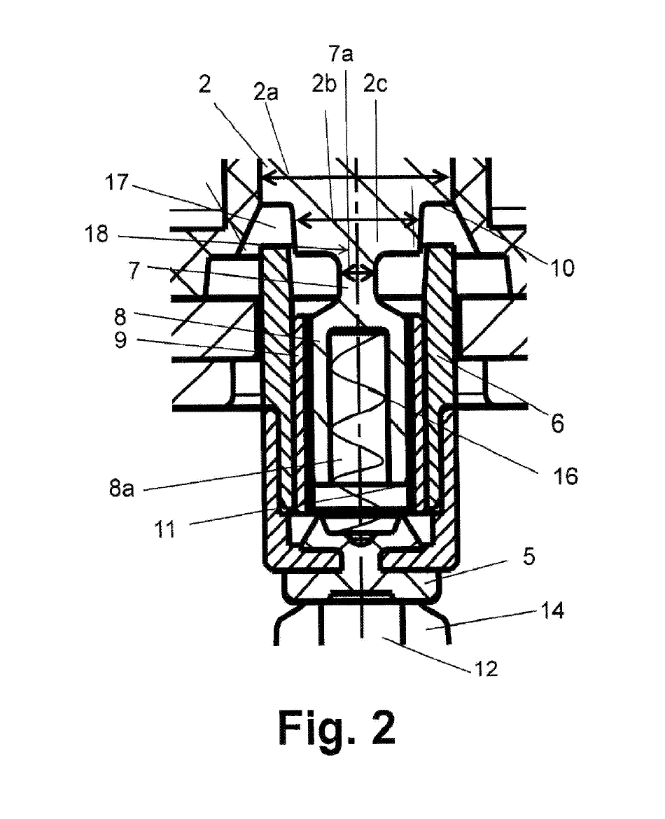

FIG. 2 shows in an enlarged view that the pole core 2 has a constriction 7 on its end facing the sealing body 5. The constriction 7 constitutes the area which is formed in such a manner that the magnetic flux is throttled or delimited in this area. The constriction 7 forms, out of the pole core 2, a guide pin 8 composed of a single material along which the armature 6 is guided. In the guide pin 8 a blind hole 8a is formed, in which a spring element 16 is held. Within the guide pin 8, a spring element 16 is arranged, against which the sealing body 5 can be moved.

Between the guide pin 8 and the armature 6, a bushing 9 is arranged.

On the pole core 2, an abutment 10 is formed, against which the armature 6 can bear in the axial direction. FIG. 2 shows that the guide pin 8 has an outer diameter which is smaller than a first outer diameter 2a of the pole core 2. In this manner, the outer circumferential surface of the armature 6 can be substantially aligned with an outer circumferential surface of the pole core 2. In the area of the constriction 7, the pole core 2 has a second outer diameter 7a which is smaller than its first outer diameter 2a. The second outer diameter 7a determines the magnitude or thickness of the constriction 7. In an area between the constriction 7 and the area of the first outer diameter 2a, the pole core 2 has a step-like area 2c with an intermediate outer diameter 2b.

The step-like area 2c extends conically and it narrows in the direction of the sealing body 5. In this manner, the armature 6, which forms an inner cone at its end that faces the step-like area 2c, can be guided with no problem. The intermediate third diameter 2b of the pole core 2 is smaller than the first outer diameter 2a of the pole core 2, but greater than the second outer diameter 7a of the pole core 2. As a result, in the pole core 2, a step-like shape is formed, which forms the abutment 10 for the armature 6. On an end face 11 of the guide pin 8, an end abutment for the sealing body 5 is provided.

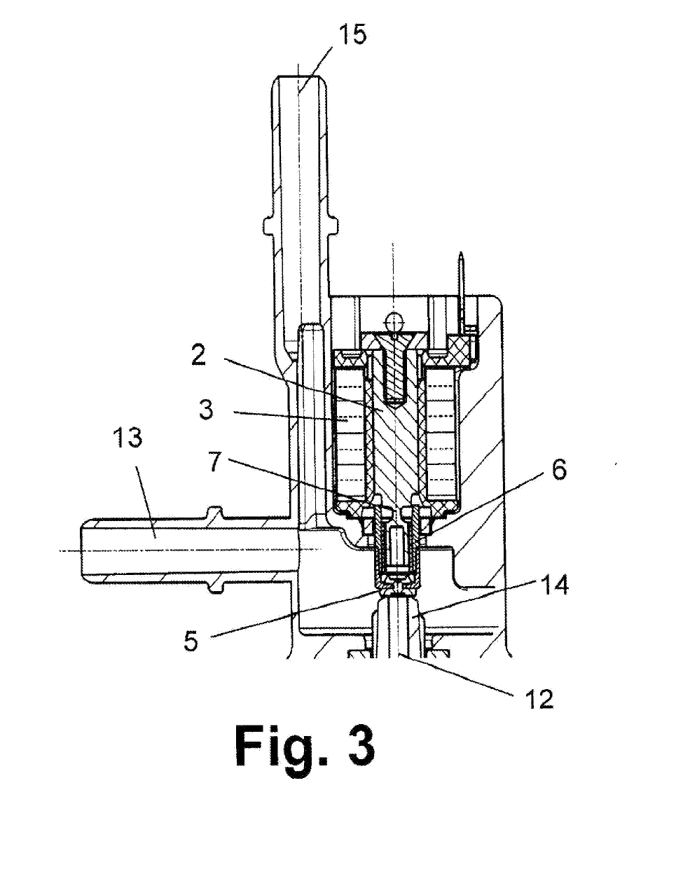

FIG. 3 shows that an inlet 12 and an outlet 13 are provided, which can be connected fluidically by raising the sealing body 5 from a sealing seat 14. On the sealing seat 14, a sealing edge is formed, against which the sealing body 5 bears in a sealing manner. The valve has a secondary outlet 15 which is permanently connected fluidically to the first outlet 13.

What is claimed is:

1. A valve comprising an electromagnetic actuation device having a pole core, a coil which encloses the pole core, and a magnetic yoke element which is associated with the coil, wherein a sealing body is provided which can be moved by a magnetic field, wherein the sealing body is connected to an armature, and wherein the armature can be moved relative to the pole core when the magnetic field is generated,
wherein the pole core projects into the armature, wherein the pole core, on its end facing the sealing body, is designed in an area in such a manner that the predominant portion of the magnetic flux, between the side of the armature that faces away from the sealing body, and the pole core, is guided through an air gap between the armature and the pole core, as a result of which the armature is pulled toward the pole core.

2. The valve according to claim 1, wherein the pole core has a constriction at its end facing the sealing body.

3. The valve according to claim 2, wherein the constriction forms, out of the pole core, a guide pin along which the armature is guided.

4. The valve according to claim 3, wherein a bushing is arranged between the guide pin and the armature.

5. The valve according to claim 3, wherein a spring element is arranged within the guide pin, against which spring element the sealing body can be moved.

6. The valve according to claim 1, wherein on the pole core, an abutment is formed, against which the armature can be applied in the axial direction.

7. The valve according to claim 3, wherein the guide pin has an outer diameter which is smaller than a first outer diameter of the pole core.

8. The valve according to claim 7, wherein the pole core, in the area of the constriction, has a second outer diameter which is smaller than its first outer diameter, wherein the pole core, in an area between the constriction and the area of the first outer diameter, has a step-like area having a third outer diameter which is smaller than its first outer diameter but greater than its second outer diameter.

9. The valve according to claim 3, wherein on the end face of the guide pin, an end abutment for the sealing body is formed.

10. The valve according to claim 1, wherein an inlet and an outlet are provided, which can be connected fluidically by raising the sealing body from a sealing seat.
